(19) United States
(12) Patent Application Publication
(10) Pub. No.: US 2026/0334345 A1
(43) Pub. Date: Oct. 29, 2026

(54) HITCH MOUNT ASSEMBLY

(71) Applicant: DEERE & COMPANY, MOLINE, IL (US)

(72) Inventors: Jason Kraus, Nashua, IA (US); KEVIN T. MCCULLOCH, Dike, IA (US); ANDREW M. TILKES, Cedar Falls, IA (US)

(21) Appl. No.: 19/190,981

(22) Filed: Apr. 28, 2025

(51) Int. Cl. A01B 59/042; B60D 1/02; B60D 1/24; B60D 1/52

(52) U.S. Cl. CPC A01B 59/042; B60D 1/02; B60D 1/246; B60D 1/52

(57) ABSTRACT

A hitch mount assembly includes a coupler including an upper portion having a first opening and a lower portion, an actuator pivotally connected to the upper portion of the coupler, the actuator at least partially positioned within a second opening in the coupler, the actuator including a first portion extending from the coupler in a disengaged position and in contact with the coupler in an engaged position, a second portion positioned closer to the first opening in the engaged position than the disengaged position, and a third portion in contact with the coupler in the disengaged position and spaced apart from the coupler in the engaged position, and an indicator pivotally connected to the actuator, a first end of the indicator positioned farther away from the second portion of the actuator in a raised position than a lowered position.

### FIELD OF THE DISCLOSURE

The present disclosure relates to a hitch mount assembly of a work vehicle.

### BACKGROUND

Work vehicles connect to implements by a hitch. Either one of the vehicles includes a drawbar with a hitch pin opening and the other vehicle includes a hitch with a hitch pin opening. To connect the vehicles, the hitch pin openings are aligned, and a hitch pin is inserted through both hitch pin openings. To disconnect the vehicles, the hitch pin is removed from the hitch pin openings.

### SUMMARY

According to an aspect of the present disclosure, a hitch mount assembly includes a coupler including an upper portion having a first opening configured to receive a hitch pin and a lower portion configured to interface with a drawbar, an actuator pivotally connected to the upper portion of the coupler, the actuator at least partially positioned within a second opening in the coupler, the actuator having an engaged position and a disengaged position, the actuator including a first portion extending from the coupler in the disengaged position and in contact with the coupler in the engaged position, a second portion positioned closer to the first opening in the engaged position than the disengaged position, and a third portion in contact with the coupler in the disengaged position and spaced apart from the coupler in the engaged position, and an indicator pivotally connected to the actuator at a position closer to a first end of the indicator than a second end of the indicator, the indicator having a lowered position and a raised position, the first end of the indicator positioned farther away from the second portion of the actuator in the raised position than the lowered position.

According to an aspect of the present disclosure, the coupler removably attaches to the drawbar.

According to an aspect of the present disclosure, the coupler forms an integral portion of the drawbar.

According to an aspect of the present disclosure, at least one of the second portion of the actuator and the first end of the indicator are configured to lift a handle of the hitch pin when the actuator rotates from the disengaged position to the engaged position.

According to an aspect of the present disclosure, the coupler includes an indentation in an upper surface configured to receive a handle of the hitch pin.

According to an aspect of the present disclosure, the second portion of the actuator includes an indentation.

According to an aspect of the present disclosure, the indicator is positioned at least partially within a channel in the actuator.

According to an aspect of the present disclosure, the position of the center of gravity of the actuator in relation to the pivotal connection of the actuator to the coupler biases the actuator in the disengaged position.

According to an aspect of the present disclosure, the position of the center of gravity of the indicator relative to the pivotal connection to the actuator biases the indicator in the lowered position.

According to an aspect of the present disclosure, the indicator includes a first visual indication and a second visual indication in an upper surface.

According to an aspect of the present disclosure, a work vehicle includes a hitch mount assembly as described herein.

The above and other features will become apparent from the following detailed description and accompanying drawings.

### BRIEF DESCRIPTION OF THE DRAWINGS

The detailed description refers to the accompanying figures in which:

FIG. 1 is a perspective view of a work vehicle connected to an implement via a hitch mount assembly, according to an implementation;

FIG. 2 is a perspective view of a hitch mount assembly, according to an implementation;

FIG. 3 is a perspective view of a hitch mount assembly, according to an implementation;

FIG. 4 is a partial cutaway view of a hitch mount assembly, according to an implementation;

FIG. 5 is a side view of a hitch mount assembly, according to an implementation;

FIG. 6 is a side view of a hitch mount assembly, according to an implementation;

FIG. 7 is a side view of a hitch mount assembly, according to an implementation;

FIG. 8 is a side view of a hitch mount assembly, according to an implementation;

FIG. 9 is a side view of a hitch mount assembly, according to an implementation;

FIG. 10 is a side view of a hitch mount assembly, according to an implementation;

FIG. 11 is a side view of a hitch mount assembly, according to an implementation;

FIG. 12 is a top view of a hitch mount assembly, according to an implementation;

FIG. 13 is an exploded view of a hitch mount assembly, according to an implementation;

FIG. 14 is an exploded view of a hitch mount assembly, according to an implementation;

FIG. 15A is a side view of an actuator for a hitch mount assembly, according to an implementation;

FIG. 15B is a top view of an actuator for a hitch mount assembly, according to an implementation;

FIG. 16A is a side view of an indicator for a hitch mount assembly, according to an implementation; and

FIG. 16B is a top view of an indicator for a hitch mount assembly, according to an implementation.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

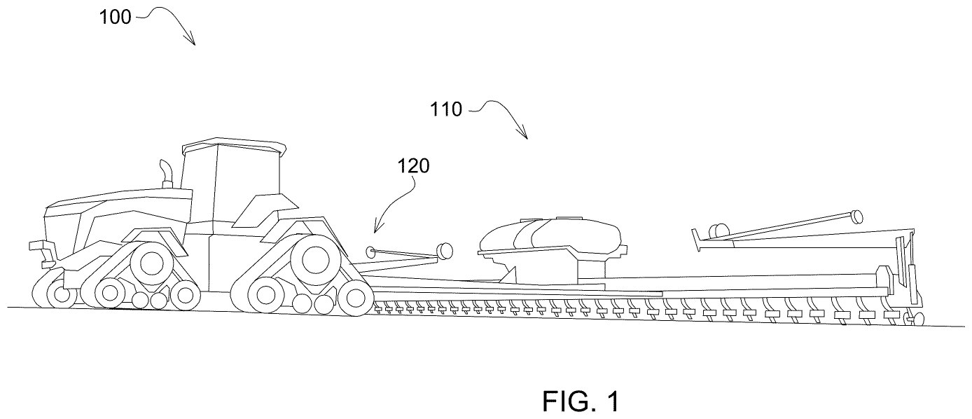

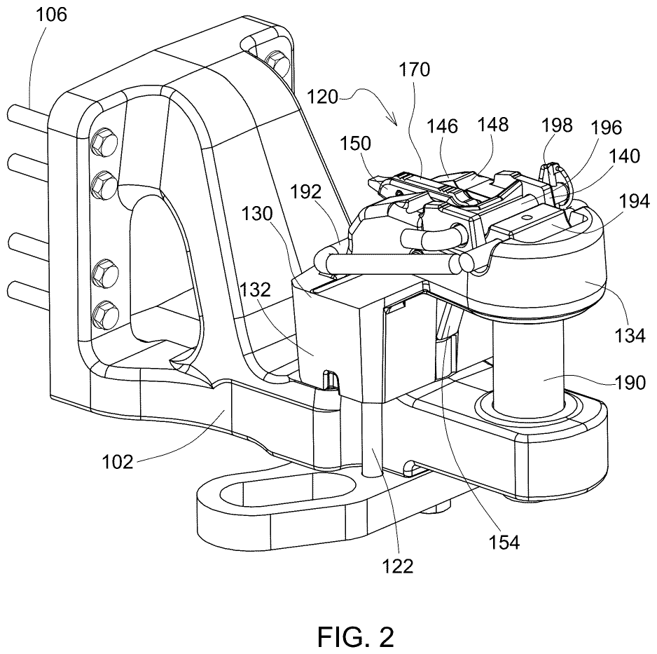

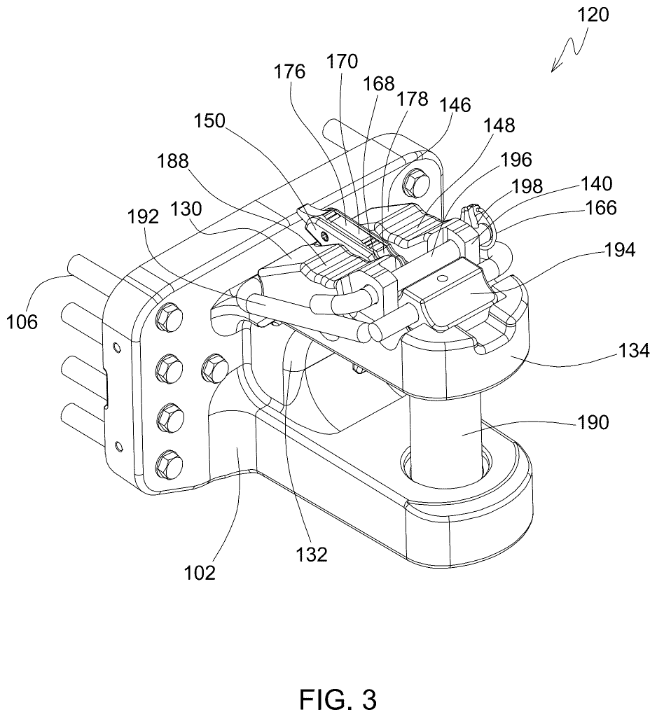

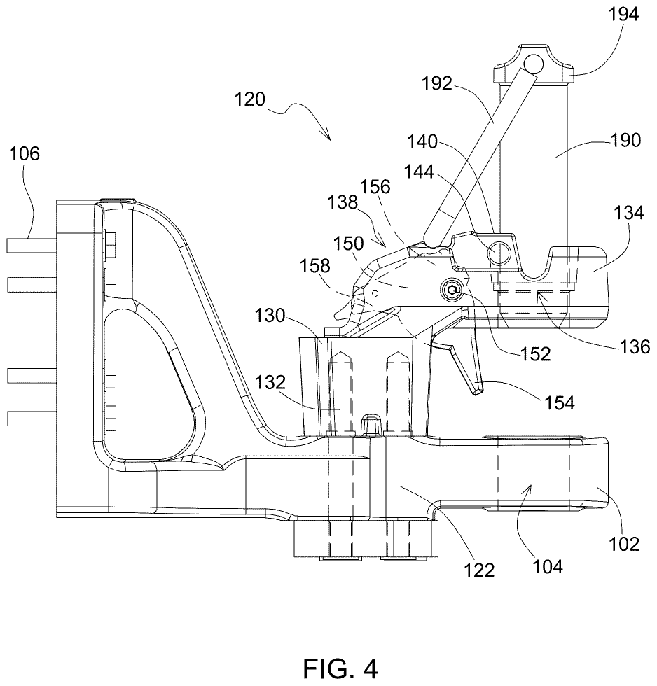

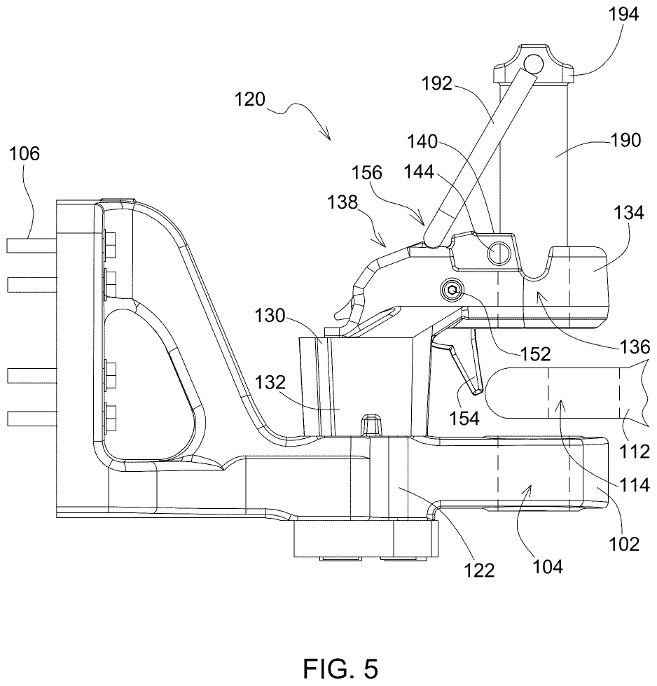

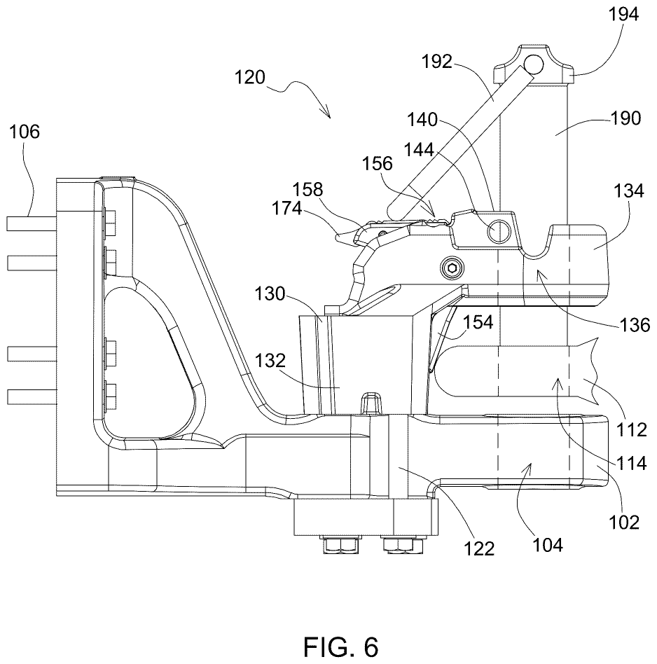

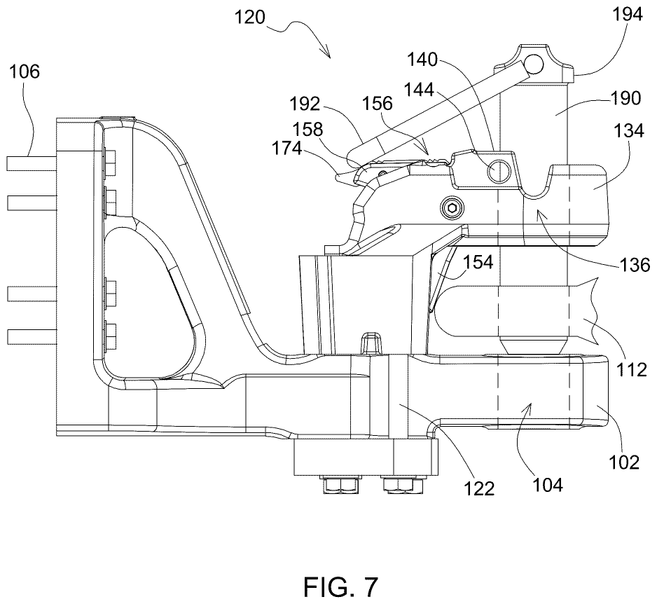

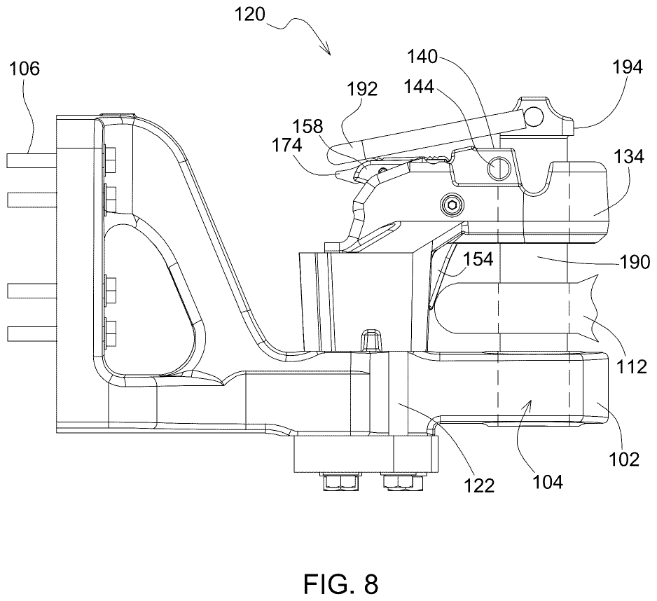

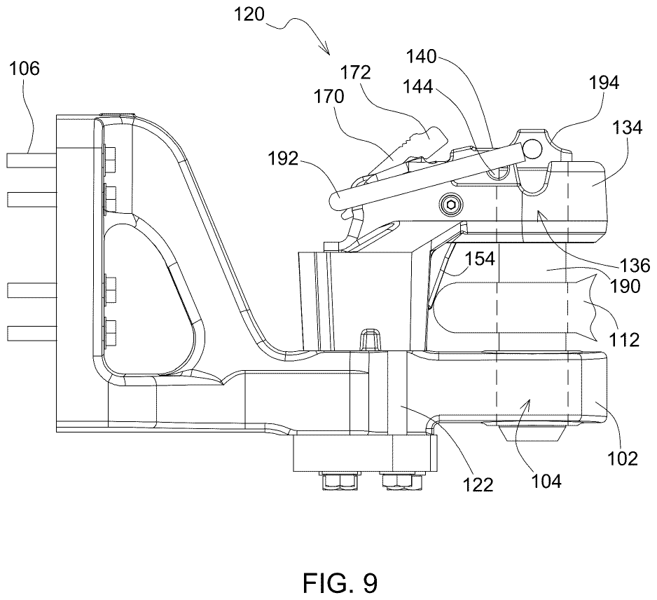

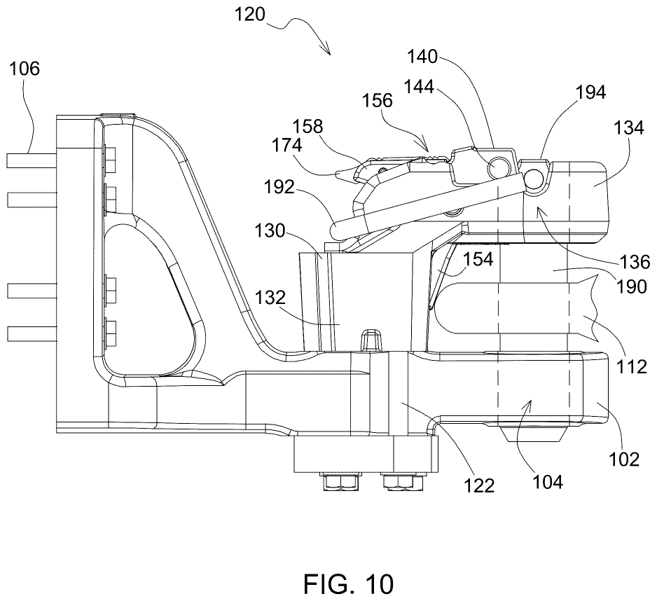

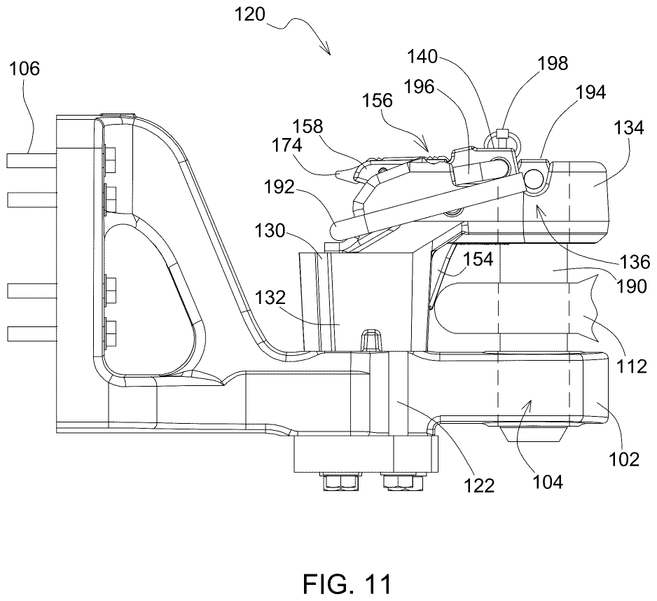

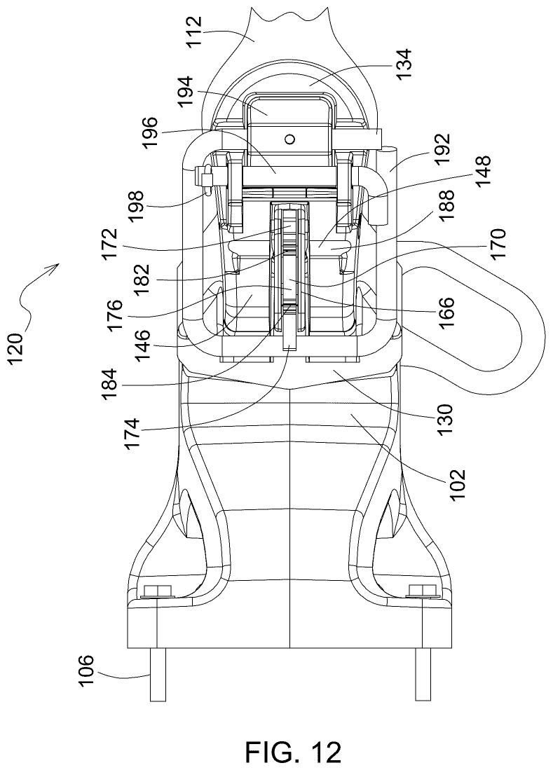

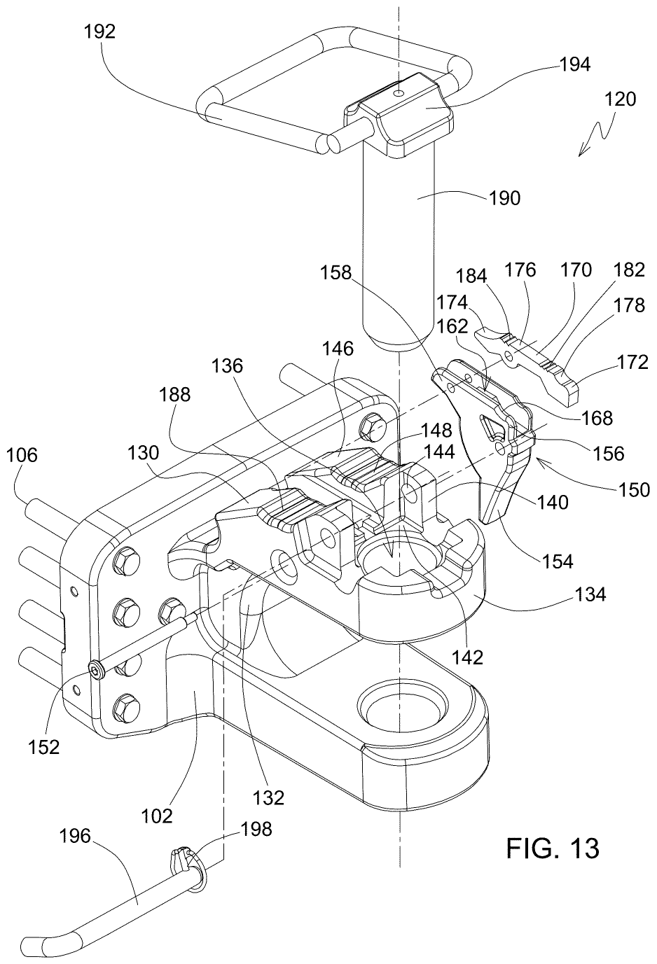

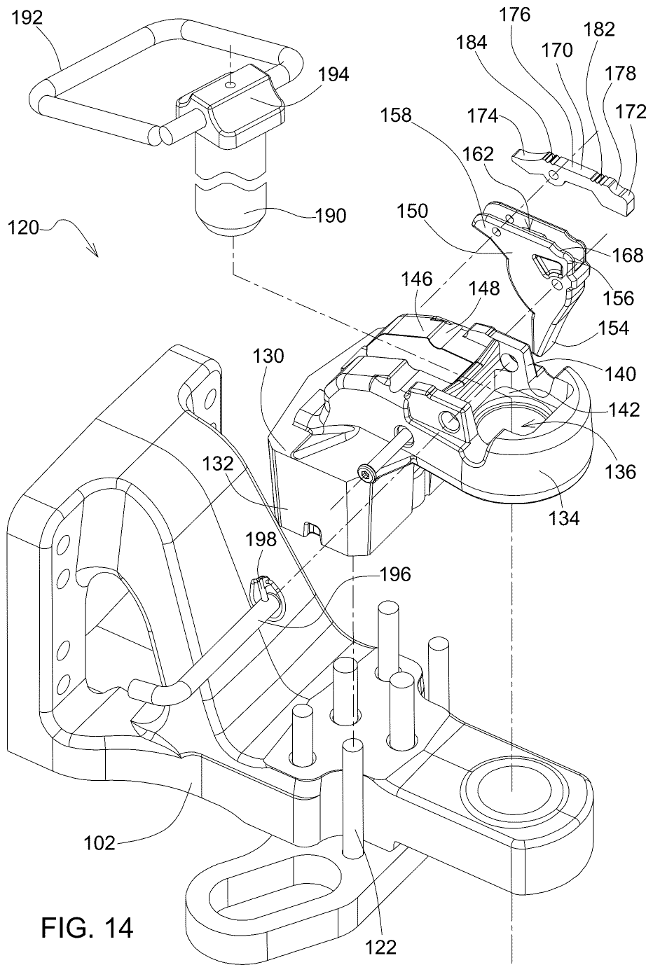

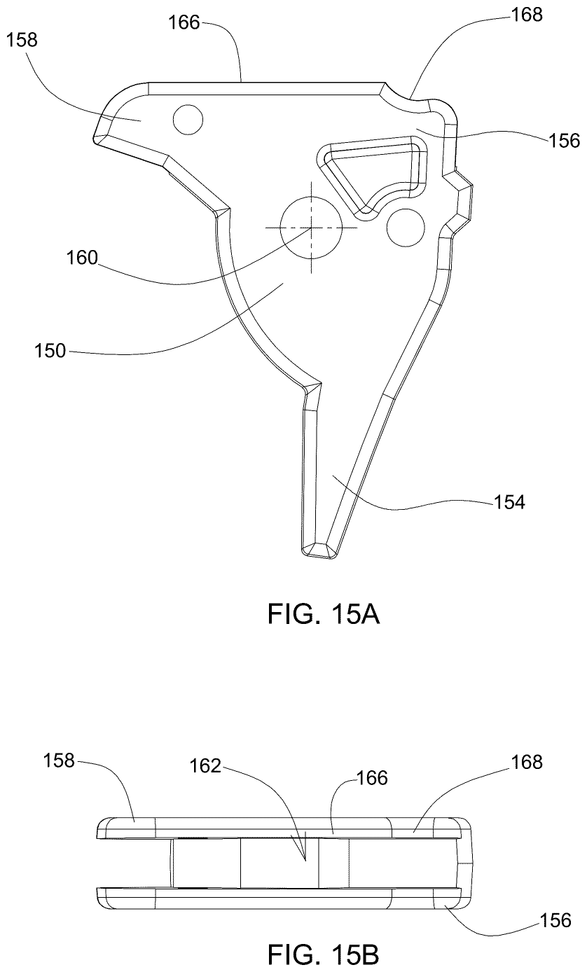

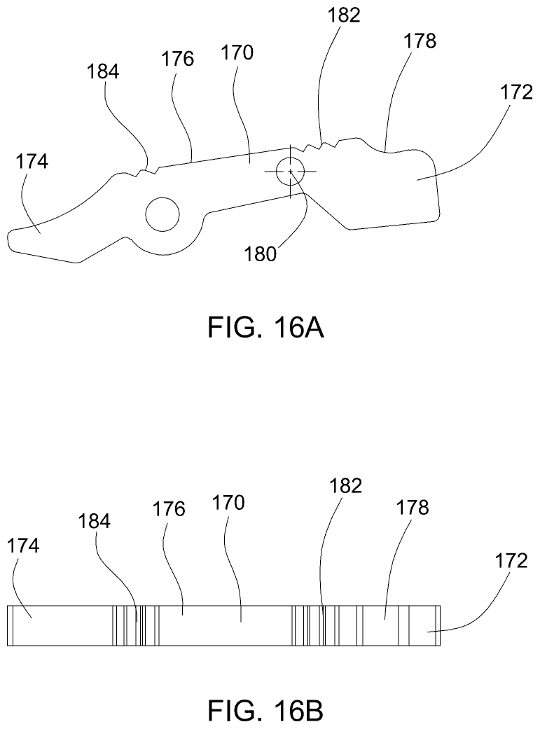

With reference to FIG. 1, a work vehicle 100, for example an agricultural tractor, can include an operator station or cab, a hood, one or more wheels or track assemblies, one or more power sources, and a rigid or articulated frame or chassis. The work vehicle 100 can connect or attach to an implement 110 via a hitch mount assembly 120.

With reference to all the FIGURES, a hitch mount assembly 120 includes a coupler 130, an actuator 150, and an indicator 170. The coupler 130 can connect or attach to a drawbar 102 or the coupler 130 can form an integral portion of the drawbar 102. The coupler 130 can connect or attach to a drawbar 102 with one or more fasteners 122. The drawbar 102 can connect to the work vehicle 100 with one or more fasteners 106. Alternatively, the drawbar 102 can connect to the work vehicle via one or more pins or in a variety of other apparatus or methods. The coupler 130 includes a lower portion 132 and an upper portion 134. The lower portion 132 contacts or interfaces with the drawbar 102. The coupler 150 can removable attach to the drawbar 102 via the lower portion 132, or the coupler 130 and the drawbar 102 can form an integral one-piece component.

The upper portion 134 extends from the lower portion 132 in a spaced apart arrangement to the drawbar 102. The upper portion 134 includes an opening 136 which can be positioned above an opening 104 in the drawbar 102. The opening 136 in the upper portion 134 of the coupler 130 can be aligned with the opening 104 in the drawbar 102. The opening 136 in the upper portion 134 of the coupler 130 and the opening 104 in the drawbar 102 can be sized to receive a drawbar or hitch pin 190. The coupler 130 includes an opening 138 forming an interior space or cavity. The opening 138 can extend through the coupler 130. The coupler 130 includes a pair of openings 144 positioned in the upper portion 134. A pair of tabs or extensions 140 can include the pair of openings 144. The coupler 130 can include an indentation 148 in an upper surface 146. This indentation 148 can receive a handle 192 of a hitch pin 190.

The actuator 150 is positioned at least partially within the opening 138 of the coupler 130. The actuator 150 can be pivotally or rotationally connected to the upper portion 134 of the coupler 130 at the pivotal connection via a pin or fastener 152. The actuator 150 includes a first portion 154, a second portion 156, and a third portion 158. The first portion 154 extends from the opening 138 in the coupler 130. The first portion 154 is positioned between the upper portion 134 of the coupler 130 and the drawbar 102. The actuator 150 can include an indentation 168 in an upper surface 166. The indentation 168 can be positioned in the second portion 156 of the actuator 150.

The actuator 150 has a disengaged position and an engaged position. The first portion 154 of the actuator 150 extends from the coupler 130 and is spaced apart from the coupler 130 in the disengaged position. The second portion 156 of the actuator 150 is positioned above the first portion 154 in the disengaged position. The third portion 158 of the actuator 150 is in contact with the coupler 130 in the disengaged position. The first portion 154 of the actuator 150 is in contact with the coupler 130 in the engaged position. The second portion 156 of the actuator 150 is positioned closer to the opening 136 in the coupler in the engaged position compared to the disengaged position. The third portion 158 of the actuator 150 is spaced apart from the coupler 130 in the engaged position. The position of the center of gravity 160 of the actuator 150 in relation to the pivotal connection of the actuator 150 to the coupler 130 provides a force or biases the actuator 150 in the disengaged position.

The indicator 170 is pivotally or rotationally connected to the actuator 150. The indicator 170 can be pivotally or rotationally connected to the actuator 150 near the third portion 158 of the actuator 150. The indicator 170 includes a first end 172 and a second end 174. The indicator 170 is pivotally connected to the actuator 150 at a position closer to the second end 174 than the first end 172 of the indicator 170. The indicator 170 can be positioned within a groove or channel 162 in the actuator 150. The indicator 170 can include an indentation 178 in an upper surface 176. The indicator 170 can include a plurality of visual indications 182 in the upper surface 176. For example, the indicator 170 can include a first visual indication 182 and second visual indication 184 spaced apart a preselected distance on the upper surface 176.

The indicator 170 has a lowered position and a raised position. The first end 172 of the indicator 170 is positioned farther away from the second portion 156 of the actuator 150 in the raised position compared to the lowered position. The position of the center of gravity 180 of the indicator 170 relative to the pivotal connection to the actuator 150 provides a force or biases the indicator 170 in the lowered position.

The hitch mount assembly 120 can include a trough or channel 188 formed by one or more of the indentation 148 in the coupler 130, the indentation 168 in the actuator 150, and the indentation 178 in the indicator 170. The channel 188 can include any combination of the indentations 148, 168, 178. For example, in some implementations, the channel 188 is formed by the indentation 148 in the coupler 130.

A drawbar or hitch pin 190 includes a handle 192 pivotally or rotatably connected to a head 194. The hitch pin 190 can be inserted into the opening 136 in the coupler 130 and the opening 104 in the drawbar 102. The coupler 130 can include a recess 142 to receive the head 194 of the hitch pin 190 at least partially within the upper portion 134 of the coupler 130. The recess 142 is larger than the opening 136 in the coupler 130. A retaining pin 196 can be positioned in the pair of openings 144 after the hitch pin 190 is installed in the opening 136 in the coupler 130 and the opening 104 in the drawbar 102. A locking pin 198 can secure the retaining pin 196 in the pair of openings 144.

The hitch pin 190 has an unhitched position and hitched position. In the unhitched position, a portion of the handle 192 is positioned in the channel 188, which maintains the hitch pin 190 in a raised position with a portion of the hitch pin 190 in the opening 136 of the coupler 130. In the hitched position, the hitch pin 190 is positioned in the opening 136 in the coupler and the opening 104 in the drawbar 102 with the handle 192 removed from the channel 188.

With continued reference to all the FIGURES, a hitch mount assembly 120 can connect a work vehicle 100 to an implement 110. To connect the work vehicle 100 to the implement 110, a hitch pin 190 is inserted into the opening 136 in the upper portion 134 of the coupler 130. The handle 192 of the hitch pin 190 is positioned in the channel 188. The actuator 150 is in the disengaged position with a third portion 158 of the actuator 150 in contact with the coupler 130. The first portion 154 of the actuator 150 extends from the coupler 130 between the upper portion 134 of the coupler 130 and the drawbar 102. The indicator 170 is in the lowered position.

The work vehicle 100 moves (e.g., reverses) towards the implement 110 so that a hitch 112 of the implement 110 is positioned between the upper portion 134 of the coupler 130 and the drawbar 102. Alternatively, or additionally, the implement 110 moves toward the work vehicle 100. The work vehicle 100 moves until the hitch 112 contacts the first portion 154 of the actuator 150, which causes the actuator 150 to rotate until the first portion 154 contacts the coupler 130. As the actuator 150 rotates from the disengaged position to the engaged position, the second portion 156 of the actuator 150 moves towards the hitch pin 190, which lifts the handle 192 of the hitch pin 190 out of the channel 188. The actuator 150, the indicator 170, or both can contact the handle 192 of the hitch pin 190 to lift it out of the channel 188. The actuator 150 can directly or indirectly, via the indicator 170, lift the handle 192 of the hitch pin 190 out of the channel 188.

The handle 192 of the hitch pin 190 then moves along the actuator 150 towards the third portion 158 of the actuator 150. Alternatively, or additionally, the handle 192 moves along the indicator 170. As the handle 192 moves along the actuator 150 away from the hitch pin 190, the hitch pin 190 lowers through the opening 136 in the coupler 130, through the opening 114 in the hitch 112, and into the opening 104 in the drawbar 102. When the handle 192 reaches the second end 174 of the indicator 170, the weight of the handle 192 causes the second end 174 of the indicator 170 to rotate downward and the first end 172 of the indicator 170 to rotate upward in the raised position. The first end 172 rises above the actuator 150 providing a visual indication the hitch pin 190 is moving towards the hitched position. The handle 192 moves downward past the second end 174 of the indicator 170 and the hitch pin 190 moves downward to the hitched position. The first end 172 of the indicator 170 rotates downward, the second end 174 of the indicator 170 rotates upward, and the indicator 170 returns to the lowered position. The handle 192 of the hitch pin 190 rests in a downward position.

A retaining pin 196 can be inserted into the pair of openings 144 after the hitch pin 190 is in the hitched position. In addition, a locking pin 198 can secure the retaining pin 196 in the pair of openings 144. The retaining pin 196 and locking pin 198 are optional components to additionally secure the hitch pin 190 in the hitched position.

To disconnect the work vehicle 100 from the implement 110, the locking pin 198 can be removed from the retaining pin 196, which can be removed from the pair of openings 144. The hitch pin 190 is removed from the hitch mount assembly 120. The work vehicle 100 is moved away from the implement 110. When the hitch 112 is no longer in contact with the hitch mount assembly 120, the actuator 150 returns to the disengaged position due to the location of the center of gravity 160 of the actuator 150 relative to the pivotal connection of the actuator 150 to the coupler 130.

According to some implementations, the hitch mount assembly 120 can provide a method to actuate and secure a drawbar or hitch pin 190 when attaching an implement 110 to a work vehicle 100. The method can be achieved or accomplished without an operator having to exit the work vehicle 100. The operator can pre-stage the hitch pin 190 in the upper portion 134 of the coupler 130 in a raised position before entering the work vehicle 100. The operator can then back the work vehicle 100 towards the implement 110 until the hitch 112 of the implement 110 engages the actuator 150, which causes the hitch pin 190 to drop through the opening 114 in the hitch 112 of the implement 110 and into the opening 104 in the drawbar 102. The implement 110 can be attached or hitched to the work vehicle 100 while the operator remains seated in the work vehicle 100.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A hitch mount assembly, comprising:
a coupler including an upper portion having a first opening configured to receive a hitch pin and a lower portion configured to interface with a drawbar;
an actuator pivotally connected to the upper portion of the coupler, the actuator at least partially positioned within a second opening in the coupler, the actuator having an engaged position and a disengaged position, the actuator including a first portion extending from the coupler in the disengaged position and in contact with the coupler in the engaged position, a second portion positioned closer to the first opening in the engaged position than the disengaged position, and a third portion in contact with the coupler in the disengaged position and spaced apart from the coupler in the engaged position; and
an indicator pivotally connected to the actuator at a position closer to a first end of the indicator than a second end of the indicator, the indicator having a lowered position and a raised position, the first end of the indicator positioned farther away from the second portion of the actuator in the raised position than the lowered position.

2. The hitch mount assembly of claim 1, wherein the coupler removable attaches to the drawbar.

3. The hitch mount assembly of claim 1, wherein the coupler forms an integral portion of the drawbar.

4. The hitch mount assembly of claim 1, wherein at least one of the second portion of the actuator and the first end of the indicator are configured to lift a handle of the hitch pin when the actuator rotates from the disengaged position to the engaged position.

5. The hitch mount assembly of claim 1, wherein the coupler includes an indentation in an upper surface configured to receive a handle of hitch pin.

6. The hitch mount assembly of claim 1, wherein the second portion of the actuator includes an indentation.

7. The hitch mount assembly of claim 1, wherein the indicator is positioned at least partially within a channel in the actuator.

8. The hitch mount assembly of claim 1, wherein the position of the center of gravity of the actuator in relation to the pivotal connection of the actuator to the coupler biases the actuator in the disengaged position.

9. The hitch mount assembly of claim 1, wherein the position of the center of gravity of the indicator relative to the pivotal connection to the actuator biases the indicator in the lowered position.

10. The hitch mount assembly of claim 1, wherein the indicator includes a first visual indication and a second visual indication in an upper surface.

11. A work vehicle including a hitch mount assembly, comprising:
a coupler including an upper portion having a first opening configured to receive a hitch pin and a lower portion configured to interface with a drawbar;
an actuator pivotally connected to the upper portion of the coupler, the actuator at least partially positioned within a second opening in the coupler, the actuator having an engaged position and a disengaged position, the actuator including a first portion extending from the coupler in the disengaged position and in contact with the coupler in the engaged position, a second portion positioned closer to the first opening in the engaged position than the disengaged position, and a third portion in contact with the coupler in the disengaged position and spaced apart from the coupler in the engaged position; and
an indicator pivotally connected to the actuator at a position closer to a first end of the indicator than a second end of the indicator, the indicator having a lowered position and a raised position, the first end of the indicator positioned farther away from the second portion of the actuator in the raised position than the lowered position.

12. The work vehicle of claim 11, wherein the coupler removable attaches to the drawbar.

13. The work vehicle of claim 11, wherein the coupler forms an integral portion of the drawbar.

14. The work vehicle of claim 11, wherein at least one of the second portion of the actuator and the first end of the indicator are configured to lift a handle of the hitch pin when the actuator rotates from the disengaged position to the engaged position.

15. The work vehicle of claim 11, wherein the coupler includes an indentation in an upper surface configured to receive a handle of the hitch pin.

16. The work vehicle of claim 11, wherein the second portion of the actuator includes an indentation.

17. The work vehicle of claim 11, wherein the indicator is positioned at least partially within a channel in the actuator.

18. The work vehicle of claim 11, wherein the position of the center of gravity of the actuator in relation to the pivotal connection of the actuator to the coupler biases the actuator in the disengaged position.

19. The work vehicle of claim 11, wherein the position of the center of gravity of the indicator relative to the pivotal connection to the actuator biases the indicator in the lowered position.

20. The work vehicle of claim 11, wherein the indicator includes a first visual indication and a second visual indication in an upper surface.
